(19) United States
(12) Patent Application Publication
(10) Pub. No.: US 2013/0222262 A1
(43) Pub. Date: Aug. 29, 2013

(54) KOREAN-LANGUAGE INPUT PANEL

(71) Applicants: Bongshin Lee, Issaquah, WA (US); Tim Paek, Redmond, WA (US); Byoung Hoon Shin, Redmond, WA (US); Yoong Ki Ahn, Redmond, WA (US); Daesung Kim, Redmond, WA (US)

(72) Inventors: Bongshin Lee, Issaquah, WA (US); Tim Paek, Redmond, WA (US); Byoung Hoon Shin, Redmond, WA (US); Yoong Ki Ahn, Redmond, WA (US); Daesung Kim, Redmond, WA (US)

(73) Assignee: Microsoft Corporation, Redmond, WA (US)

(21) Appl. No.: 13/406,531

(22) Filed: Feb. 28, 2012

(51) Int. Cl. G06F 3/02

(52) U.S. Cl. 345/171

(57) ABSTRACT

The current application is directed to intuitive, easily manipulated, and fully functional soft-input panels (“SIPs”) and hardware input panels (“HIPs”), or physical keyboards, for mobile telephones, tablet computers, and other electronic devices that provide for input of Korean-language text. One implementation of the Korean-language SIP to which the current application is directed includes 16 different displayed input features arranged in four columns and four rows. The 16 input features of this particular implementation allow for input of all Hangul Korean-language characters as well as cursor control, text-entry control, and alternate-SIP toggles. Neither this section nor the sections which follow are intended to either limit the scope of the claims which follow or define the scope of those claims.

### TECHNICAL FIELD

The current patent application is directed to an intuitive, fully functional, and easily manipulated Korean-language input panels through which users of electronic devices input Korean-language text.

### BACKGROUND

Soft-input panels, or virtual keyboards, are electronically displayed user interfaces for input of symbols to a touchscreen or other user-input electronic devices. Although ubiquitous and familiar to users of mobile phones, electronic kiosks, and other electronic equipment and devices that employ soft-input panels (“SIPs”), significant research-and-development efforts continue to be expended by manufacturers and vendors of electronic devices and operating systems to develop soft-input panels that provide intuitive, easy-to-manipulate user interfaces that meet or exceed various goals under a variety of different constraints associated with particular device and operating-system contexts. For example, text input through user interfaces of mobile phones is often carried out by users using a single thumb while holding the mobile phone with the fingers of one hand. In this context, a desirable SIP may have input features arranged for single-digit accessibility, constrained by the generally low accuracy by which users using only a single thumb or digit while holding the mobile phone can touch particular positions of a touch screen. Additional constraints may be associated with particular languages input to an electronic device through text-entry SIPs. Different languages have different numbers of symbols and characters with different associated input and occurrence frequencies and many other language-specific constraints. There may also be historical user interfaces employed in previously encountered input devices or in previous generations of current electronic devices that have established user preferences and expectations that represent constraints and goals for new SIPs. Many of the same considerations and constraints associated with the design and development of soft-input panels also apply to hardware input panels (“HIPs”) or keyboards, which include physical keys that are imprinted and labelled with corresponding input symbols or which include display elements that electronically display corresponding input symbols. For all of these reasons, the development of intuitive, functional, and easily manipulated SIPs and HIPs represents a continuing area of research and development for manufacturers and vendors of a wide variety of different types of electronic devices and control programs.

### SUMMARY

The current application is directed to intuitive, easily manipulated, and fully functional soft-input panels (“SIPs”) and hardware input panels (“HIPs”), or physical keyboards, for mobile telephones, tablet computers, and other electronic devices that provide for input of Korean-language text. One implementation of the Korean-language SIP to which the current application is directed includes 16 different displayed input features arranged in four columns and four rows. The 16 input features of this particular implementation allow for input of all Hangul Korean-language characters as well as cursor control, text-entry control, and alternate-SIP toggles. Neither this section nor the sections which follow are intended to either limit the scope of the claims which follow or define the scope of those claims.

### BRIEF DESCRIPTION OF THE DRAWINGS

FIG. 1 illustrates a cell phone and cellular radio tower.

FIG. 2 illustrates partitioning of a geographical region into cells.

FIG. 3 illustrates certain of the components of a 3G telecommunications network.

FIG. 4 provides a high-level block diagram for certain of the internal components of a cell phone.

FIG. 5 shows a high-level block diagram for a digital cellular baseband integrated circuit.

FIG. 6 provides a high-level block diagram of the software architecture for a cellular telephone.

FIG. 7 illustrates a soft-input panel (“SIP”) displayed on the touchscreen of a mobile phone.

FIGS. 8A-C show the characters of the Hangul alphabet.

FIG. 9 shows nine patterns by which the Hangul characters, shown in FIGS. 8A-C, are combined to form morpho-syllabic blocks.

FIG. 10 illustrates a hypothetical, arbitrary soft-input panel.

FIG. 11 illustrates a first type of user-input operation with respect to the hypothetical SIP shown in FIG. 10.

FIG. 12 illustrates a second type of user-input operation, using the illustration conventions of FIGS. 10-11.

FIG. 13 illustrates various different gesture symbols representing different input gestures.

FIG. 14 illustrates a third type of user-input operation, using the illustration conventions of FIGS. 10-13.

FIG. 15 illustrates a fourth type of user-input operation, using the illustration conventions of FIGS. 10-14.

FIG. 16 shows one implementation of the 16-key Korean-language SIP to which the current application is directed.

FIG. 17 shows the 16-key Korean-language SIP of FIG. 16 with superimposed crosshatching to indicate three functional regions of the 16-key Korean-language SIP.

FIG. 18 illustrates two different types of gestures used with certain of the keys corresponding to consonants within the 16-key Korean-language SIP shown in FIG. 16.

FIGS. 19 and 20 show input of Hangul vowel characters using the 16-key Korean-language SIP shown in FIG. 16.

FIG. 21 shows the 16-key Korean-language SIP of FIG. 15 with circled frequency-of-occurrence ranks associated with each of the displayed consonant characters.

FIG. 22 shows the keys and key sequences used to input consonants via the 16-key Korean-language SIP shown in FIG. 16.

FIG. 23 shows the region-based gestures used to compose each of the Hangul vowels via the 16-key Korean-language SIP shown in FIG. 16.

FIG. 24 illustrates a general-purpose computer system.

### DETAILED DESCRIPTION OF EMBODIMENTS

The current application is directed to intuitive, easily manipulated, and fully functional Korean-language SIPs and HIPs for input of Korean-language Hangul characters to various types of electronic devices, including mobile phones. The current application includes four subsections: (1) an overview of mobile-phone technology; (2) an overview of the Hangul Korean-language characters; (3) a description of different types of user inputs to an SIP; and (4) a detailed description of the 16-key Korean-language SIP to which the current application is directed. Although the current discussion focuses on Korean-language SIPs, the below-described design and layout of Korean-language SIPs may also be incorporated within Korean-language HIPs. Korean-language SIPs and HIPs are collectively referred to as “input panels” in the following discussion and claims.

### Overview of Cell Phones and Telecommunications Systems

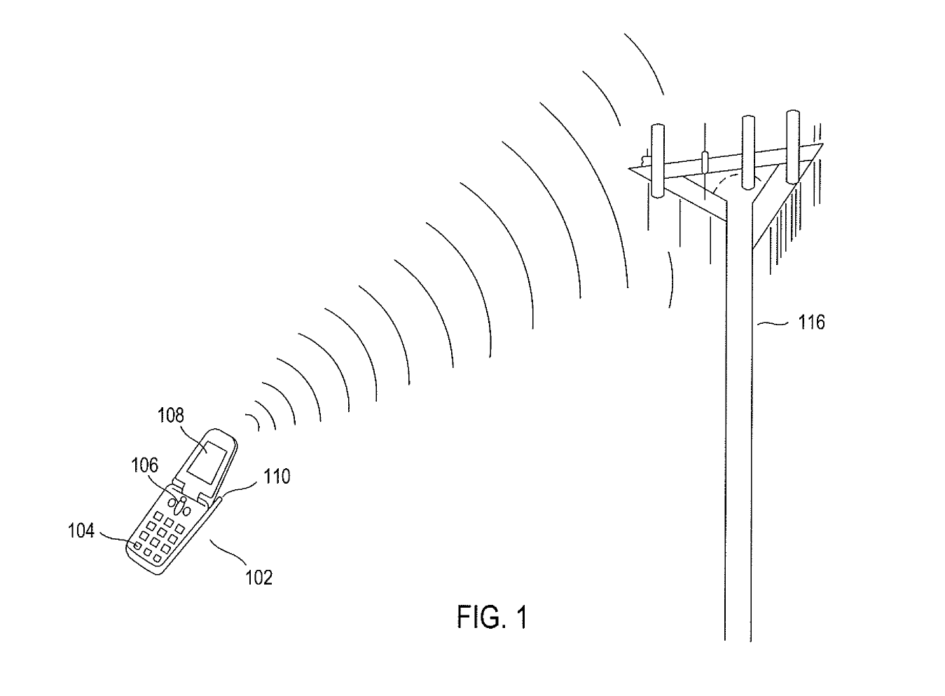

FIG. 1 illustrates a cell phone and cellular radio tower. The cell phone 102 is generally a compact, hand-held device that includes alphanumeric-character input keys, such as key 104, for input of numeric and text-character data, various control keys 106, for navigation through user-interface displays and menus, an LCD display 108, and a radio-frequency antenna 110. The cell phone broadcasts radio-frequency signals to, and receives radio-frequency signals from, one or more local cellular radio towers 116. The radio-frequency signals are multiplexed by frequency-division-multiple-access (“FDMA”) or code-division-multiple-access (“CDMA”) multiplexing to allow many cell telephones to broadcast and receive signals from multiple cellular radio towers within a local geographical area.

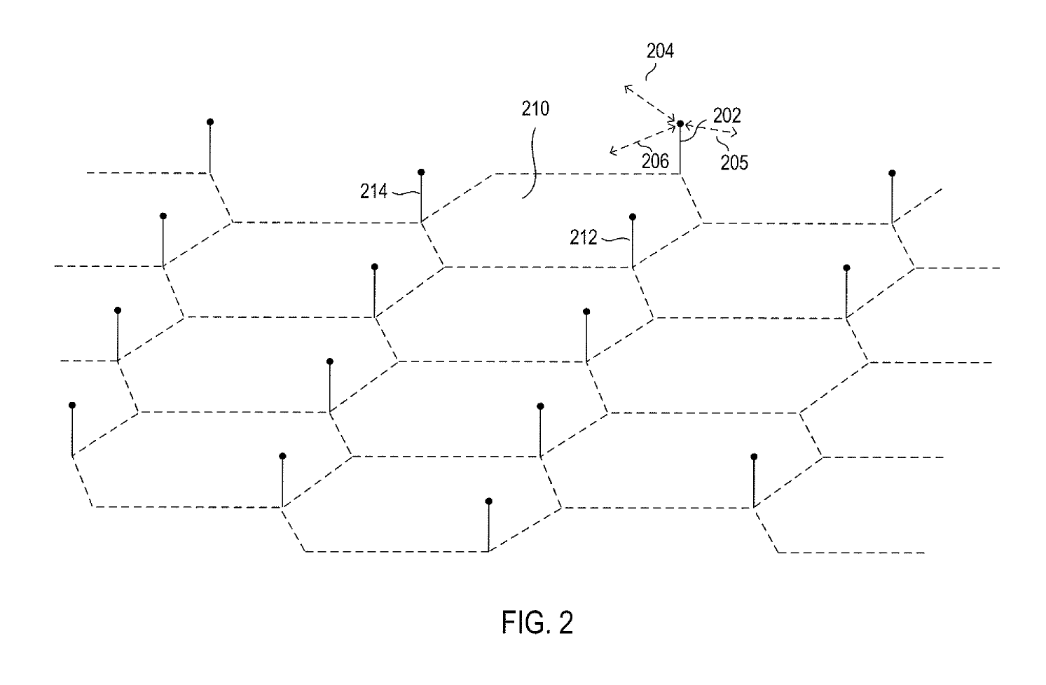

The word “cell” in the phrase “cell phone” and the word “cellular” in the phrases “cellular network” and “cellular radio tower” refers to the partitioning of a geographical region into generally hexagonally-shaped sub-regions, referred to as “cells,” by the locations and directional broadcast characteristics of a number of cellular radio towers. FIG. 2 illustrates partitioning of a geographical region into cells. In FIG. 2, a large number of cellular radio towers are depicted as vertical line segments capped with a small disk, such as vertical line segment 202. Each cellular radio tower generally includes a three-sided, or triangular, antenna mount that allows for broadcast and reception or radio signals roughly aligned with three directional, co-planar axes separated from one another by 120°, such as the three axes 204-206 shown for cellular radio tower 202. The geographical region is subdivided into hexagonal cells, indicated in FIG. 2 by dashed lines. Hexagonal cell 210 is served by cellular radio towers 202, 212, and 214, each with a directional broadcast axis directed towards the center of the cell. A cell-telephone user may walk or drive from one cell to another, and the network of cellular radio towers, associated base stations connected to a complex telecommunications network, allows the telecommunications network to transfer the mobile-electronic device, in real time, from broadcasting and receiving signals from the cellular radio towers associated with one cell to those associated with another, without interruption in an on-going phone call or electronic data-exchange operation.

There are a variety of different types of mobile telecommunications systems. One common mobile telecommunications system is referred to as the “universal mobile telecommunication system” (“UMTS”), one of several third-generation (“3G”) mobile telecommunications technologies. The UMTS system supports data transfer rates up to 21 Mbit/second, although, with current handsets, maximum data-transfer rates generally do not exceed 7.2 Mbit/second. UMTS systems provide for cells of varying sizes, depending on population density, presence of buildings and other obstacles, and other considerations. In rural areas, cellular telephone towers may be separated by distances greater than 30 miles, while, in certain urban environments, a cell may span a single floor of a building.

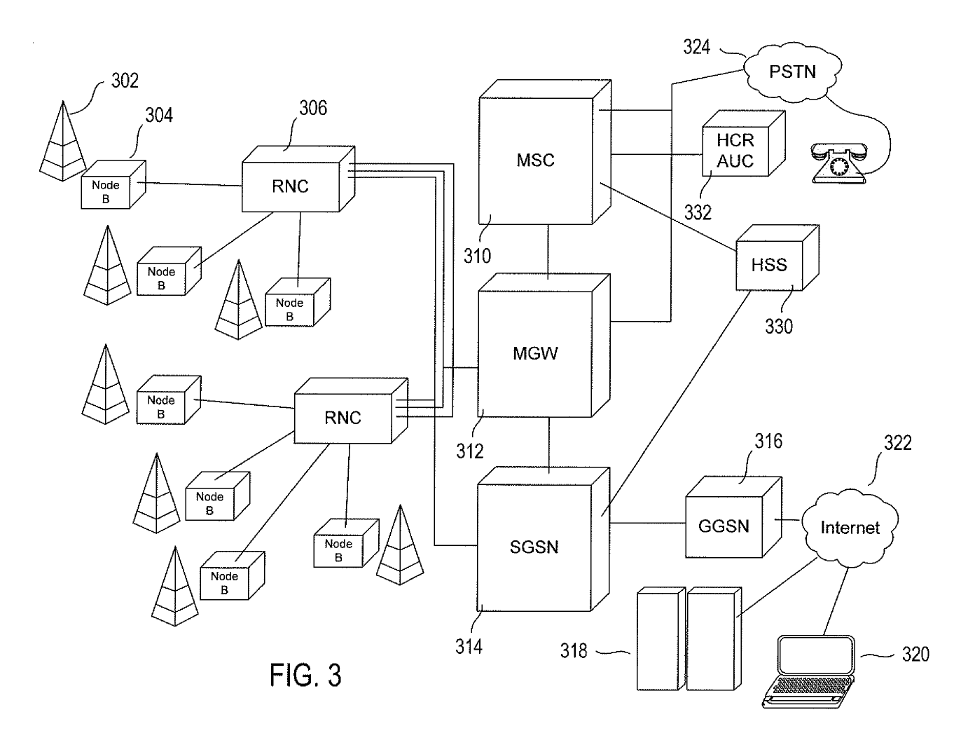

FIG. 3 illustrates certain of the components of a 3G telecommunications network. In FIG. 3, cellular telephone towers and other antennas are indicated by antenna-like symbols, such as antenna-like symbol 302. Each cellular radio tower, or other antenna, is associated with a Node B base station, such as Node B base station 304 with which antenna 302 is associated. A single Node B base station may be associated with multiple antennas or cellular radio towers. The base stations include power amplifiers, digital-signal processors, and back-up batteries, and are generally responsible for broadcasting signals received by the base station from the cellular network to cell phones within the geographical area serviced by the base station and for forwarding signals received from cell phones to the cellular network. Base stations are directly connected to radio network controllers (“RNC”), such as RNC 306 in FIG. 3. Each RNC may be connected to multiple base stations. The RNCs are, in turn, connected to various components of the core cellular network, including a mobile switching center (“MSC”) 310, a media gateway (“MGW”) 312, and a serving GPRS support node (“SGSN”) 314, the acronym “GPRS” standing for “general packet radio service.” The SGSN 314 interconnects RNCs, via gateway GPRS support nodes (“GGSN”) 316, to remote computing systems 318 and 320 via the Internet 322. The MSC 310 interconnects RNCs with a public switched telecommunications network (“PSTN”) 324. The MGW 312 is concerned with data transfer in both circuit-based switch networks, such as PSTN, as well as in packet-based switch networks, such as the Internet, and is controlled by SGSNs and MSCs. Many additional components are included in the core telecommunications network, including a home-subscriber-server facility 330, home-location-register and authentication center 332, and many additional components and nodes not shown in FIG. 3.

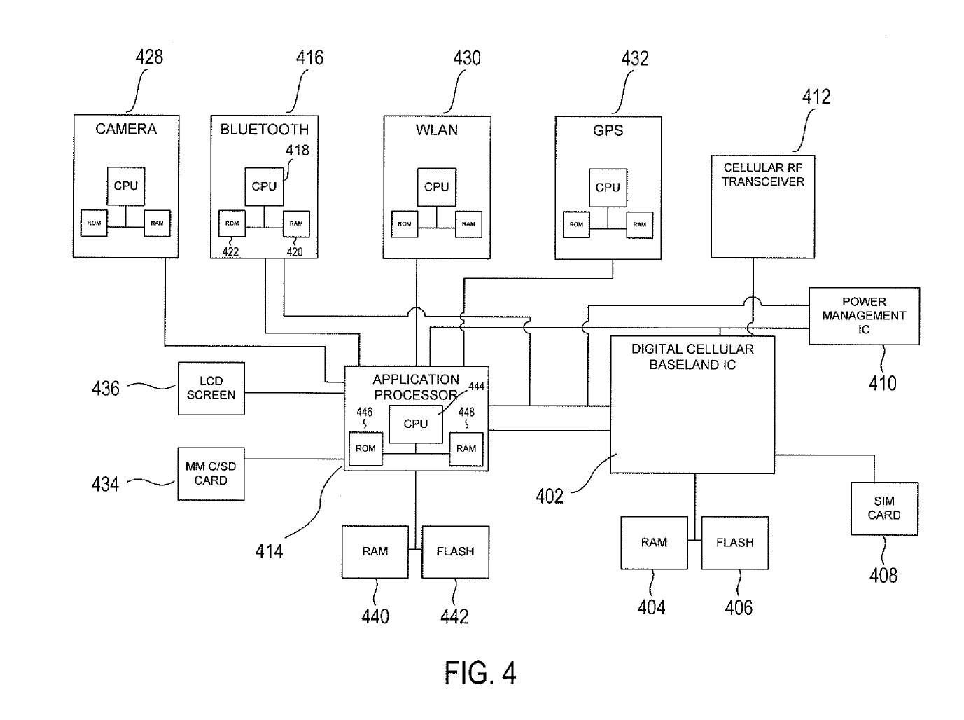

FIG. 4 provides a high-level block diagram for certain of the internal components of a cell phone. Referring first to FIG. 4A, these components include a dual-core digital cellular baseband integrated circuit 402, which converts analog radio signals to digital signals and digital signals to analog signals, manages communications-protocol layers, and runs certain cell telephone applications, including applications responsible for initiation of phone-calls and maintenance of a locally-stored phone book, and a portion of the cell-phone user interface. The digital cellular baseband integrated circuit is interconnected with external RAM 404 and flash 406 memory, a subscriber identity module (“SIM”), or SIM card, 408, a power-management integrated circuit 410, a cellular radio-frequency (“RF”) transceiver 412, a separate application processor integrated circuit 414, and a Bluetooth module 416 that includes a processor 418 and both RAM 420 and ROM memory 422. The application processor 414 provides the computational bandwidth to a variety of non-radio-communications applications, including digital-camera-based applications, Internet browser, games, networking, and GPS-related functions. An application processor may be connected to a video camera 428, a WLAN module 430, a GPS module 432, an MMC/SD card 434, and an LCD screen 436. The application processor is additionally interconnected with external RAM 440 and flash 442 memories, and includes a processor 444 and internal ROM 446 and RAM 448 memory. On modern cell phones, the display screen 436 is generally a touch screen that both displays graphics, text, and images and that receives user input. The user input includes touch input at particular screen positions and/or continuous motions including one or more of initial points of the continuous motion, a direction of the continuous motion, and final point at which the continuous motion terminates.

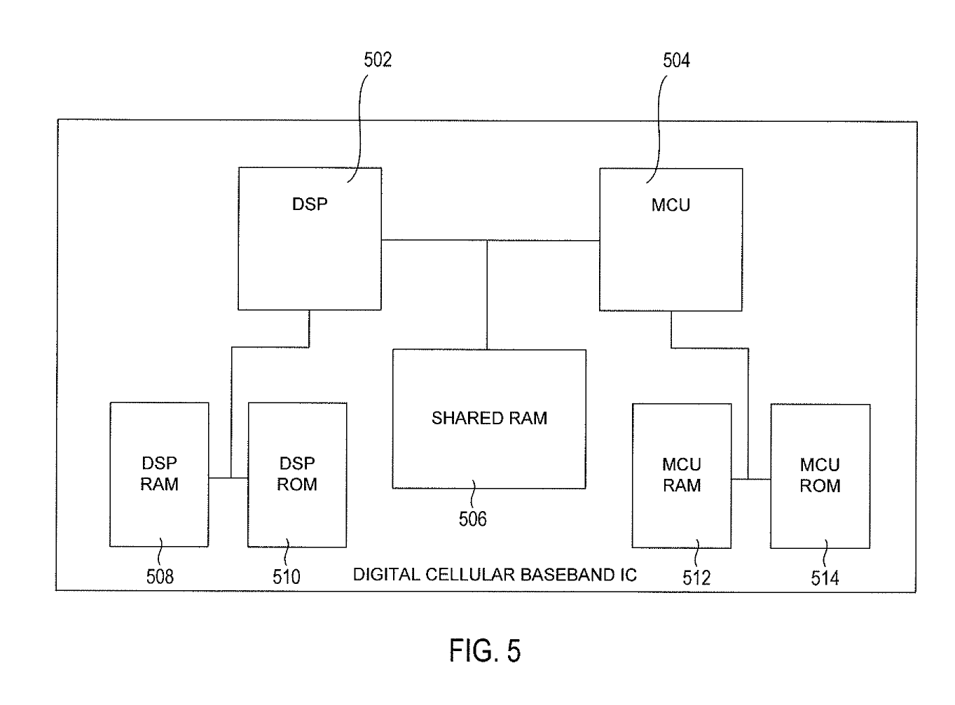

FIG. 5 shows a high-level block diagram for a digital cellular baseband integrated circuit. The digital cellular baseband integrated circuit (402 in FIG. 4) includes a digital signal processor (“DSP”) 502, a microcontroller 504, shared internal RAM 506, and DSP-associated RAM 508 and ROM 510 as well as microcontroller-associated RAM 512 and ROM 514.

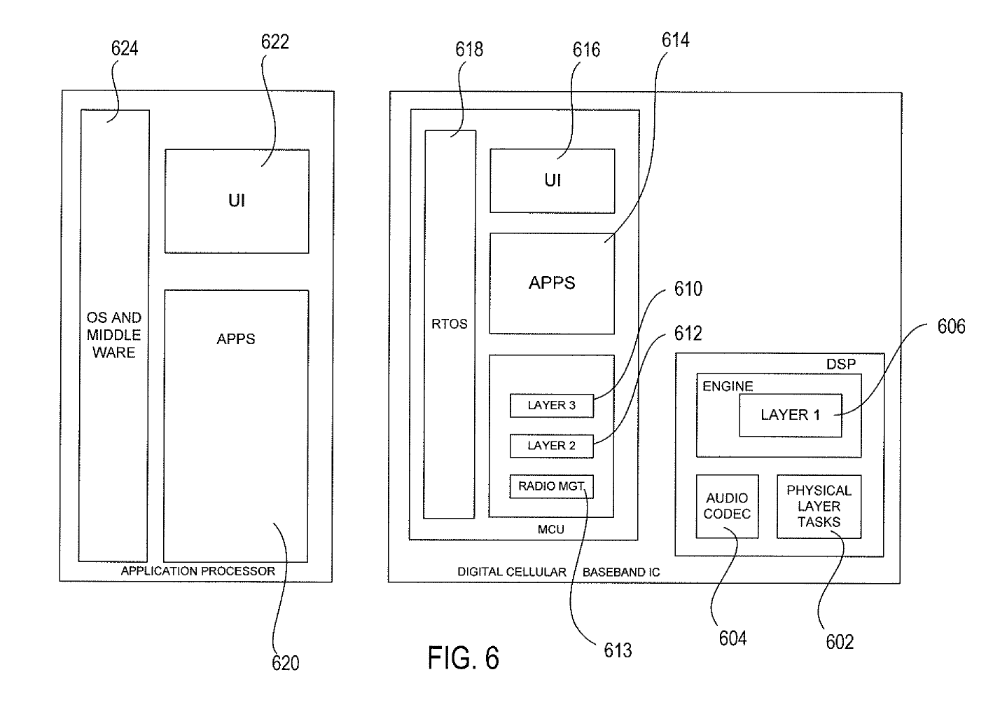

FIG. 6 provides a high-level block diagram of the software architecture for a cellular telephone. The DSP (502 in FIG. 5) is responsible for the physical layer of the protocol stack associated with RF broadcast and reception 602, provides an audio codec 604, and carries out tasks associated with the first layer of a three-layer communications-protocol stack 606. The microcontroller (504 in FIG. 5) executes software that implements the upper two layers of the three-layer protocol stack 610 and 612, various radio-management functions 614, and executes certain applications 614 and user-interface routines 616 layered above a real-time operating system 618. For example, the microcontroller may store and manage a local phone book and provide a user-interface (“UI”) for initiating and answering phone calls, via a phone application the executes on the microcontroller. The application processor (414 in FIG. 4) runs numerous software applications 620 and UI routines 622 above an operating system and a middle-ware layer 624, including a web browser and many different types of applications programs, including games, utilities, dictionaries, and other applications.

A cell phone thus generally contains, at a minimum, three processors, including an application processor, microcontroller, and DSP, and often as many as six or more processors, including processors within separate Bluetooth, GPS, and WLAN modules. The cell phone includes various different electronic memories, some integrated with the processors and others external to the processors and interconnected with the processors via memory busses.

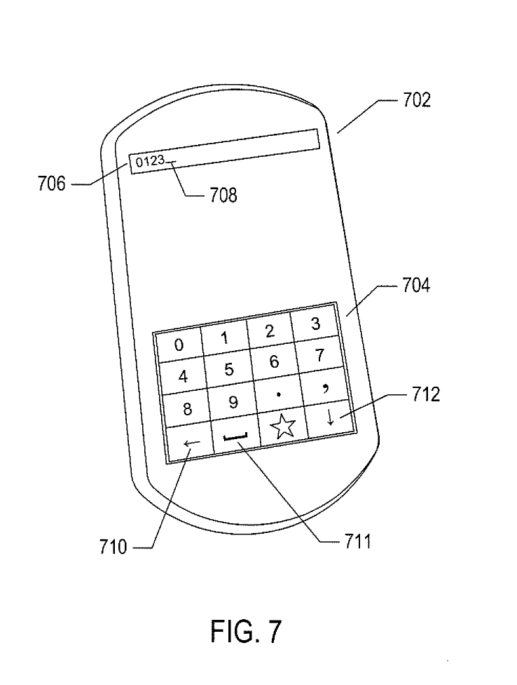

FIG. 7 illustrates a soft-input panel (“SIP”) displayed on the touchscreen of a mobile phone. The mobile phone 702 in FIG. 7 includes a touchscreen that covers most of the visible surface of the mobile phone. The mobile phone currently displays a 16-key SIP 704 as well as a symbol-entry window 706 that displays a sequence of symbols entered into the symbol-entry window by touch-based user input to the SIP. A small display underline feature 708 indicates a current cursor position within the sequence of symbols displayed in the symbol-input window 706. As a user touches successive keys of the SIP, symbols corresponding to the touched keys are sequentially entered into the symbol-entry window 706. Various input keys may control the position of the cursor, such as key 710 and key 711, and an additional key 712 may serve to indicate completion of a line of input symbols desired by a user of the mobile phone and direct a control program to process, package, and transfer the input symbol to an application program executing within the mobile phone.

It should be noted that an SIP is not an abstract or entirely-software-implemented component of a mobile phone or other electronic device, but is, instead, a physical and concrete user interface that is manipulated by human users and through which human users create symbol sequences and transfer the symbol sequences to electronic memory within the mobile phone or other electronic device for storage and for access by various application programs. An SIP is visible, responds to user input, and carries out real-world tasks involving many different physical transformations. An SIP is no less a device component than the memories, processors, and logic circuits within a mobile phone or other electronic device.

### Overview of the Korean-Language Hangul Characters

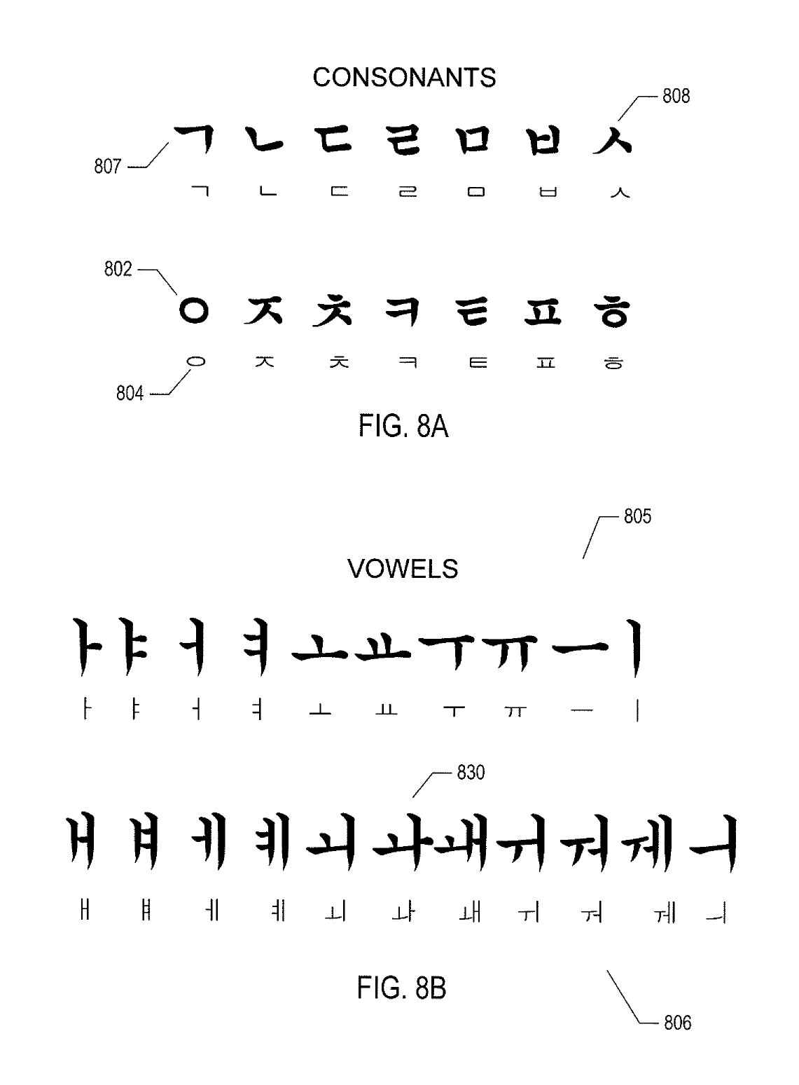

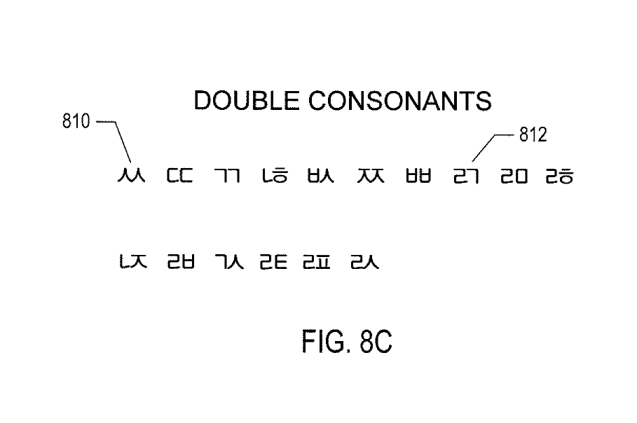

Although many people unfamiliar with the Korean language assume that the Korean language is written with Chinese-like characters, it is actually written using the Hangul alphabet. FIGS. 8A-C show the characters of the Hangul alphabet. FIG. 8A shows simple consonants of the Hangul alphabet. Each consonant is shown in two different fonts. For example, the consonant ieung is shown in a first script-like font 802 as well as in a block-printing-like font 804. FIG. 8B shows the 21 vowels of the Hangul alphabet. A first row 805 includes simple vowels and a second row 806 includes complex vowels. As in FIG. 8A, each vowel is shown in two different fonts, including a script-like font and a block-printing-like font. As described further below, all of the vowels are composed of one or more of three basic strokes: (1) a vertical stroke; (2) a horizontal stroke; and (3) either a vertical or horizontal short stroke. FIG. 8C illustrates a number of additional Hangul characters that each comprises a sequence of two consonants from the list of basic consonants shown in FIG. 8A. For example, the character ssangsiot 810 is composed of two instances of the character slot (808 in FIG. 8A).

It is interesting to note that the Hangul alphabet was invented in the year 1444 by King Sejong. The Hangul characters and writing system is remarkably systematic and rational, as a result of having been deliberately formulated, rather than evolving over time.

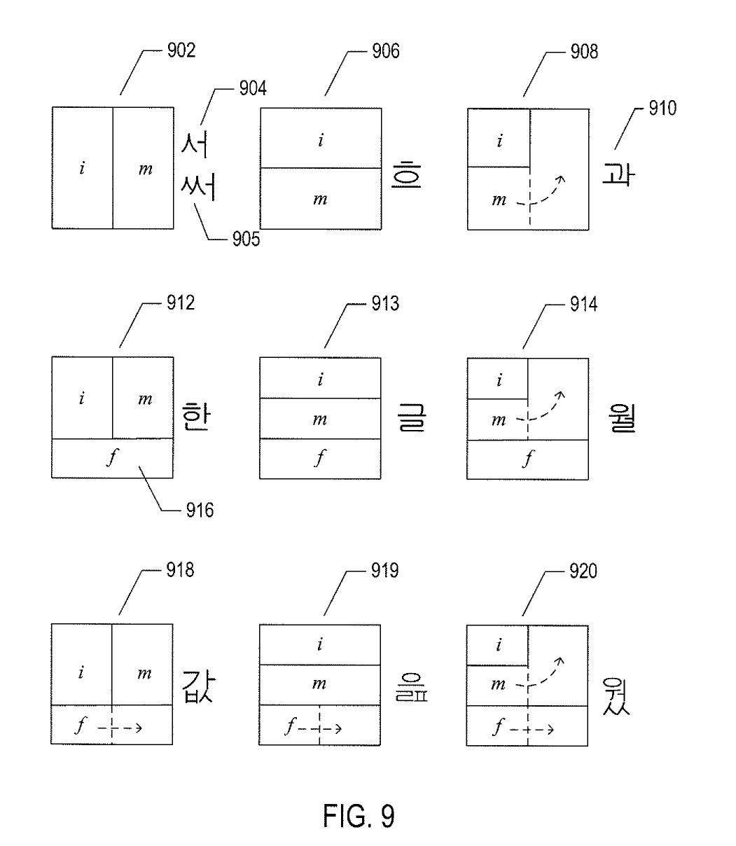

In the Hangul writing system, the characters are combined in blocks that represent morphemes and syllables. FIG. 9 shows nine patterns by which the Hangul characters, shown in FIGS. 8A-C, are combined to form morpho-syllabic blocks. In a first pattern 902, an initial consonant, which can be either a simple or double consonant, is combined with a single vowel in a horizontal two-character sequence. In FIG. 9, of the letter “i” stands for the initial consonant and the letter “m” stands for the medial vowel that together comprise a morpheme or syllable. Certain blocks additionally include a final consonant, represented in FIG. 9 by the letter “f.” Two examples of morpho-syllabic blocks 904 and 905 constructed according to the pattern 902 are shown to the right of the first pattern 902. The first example 904 includes a simple-consonant initial consonant and the second example 905 includes a double-consonant initial consonant. In a second pattern 906, the initial consonant and medial vowel are arranged vertically. In a third pattern 908, the initial consonant is placed in the upper left-hand corner of the block, and a medial vowel that includes both horizontal and vertical components fills the remaining portion of the block. An example morpho-syllabic block 910 constructed according to this third pattern 908 is shown to the right of the pattern description. This example morpho-syllabic block is composed of the consonant giyeok (807 in FIG. 8A) and the complex vowel wa (830 in FIG. 8B). Three additional block-construction patterns 912-914 are similar to patterns 902, 906, and 908, respectively, with the addition of a simple-consonant final consonant underlying each pattern. As an example, pattern 912 includes a horizontally ordered initial consonant and medial vowel as well as a final consonant 916 underlying the initial consonant and medial vowel. Three final patterns 918-920 include double-consonant final consonants rather than single final consonants.

The organization of basic Hangul characters into morpho-syllabic blocks is probably the basis for the common misunderstanding that the Korean-language is written in Chinese-like characters. The use of morpho-syllabic blocks to represent morphemes and syllables may contribute to a greater natural readability of the Korean-language in contrast to linearly written languages, such as English, and character-based languages, such as Chinese.

### Various Types of User Inputs to an SIP

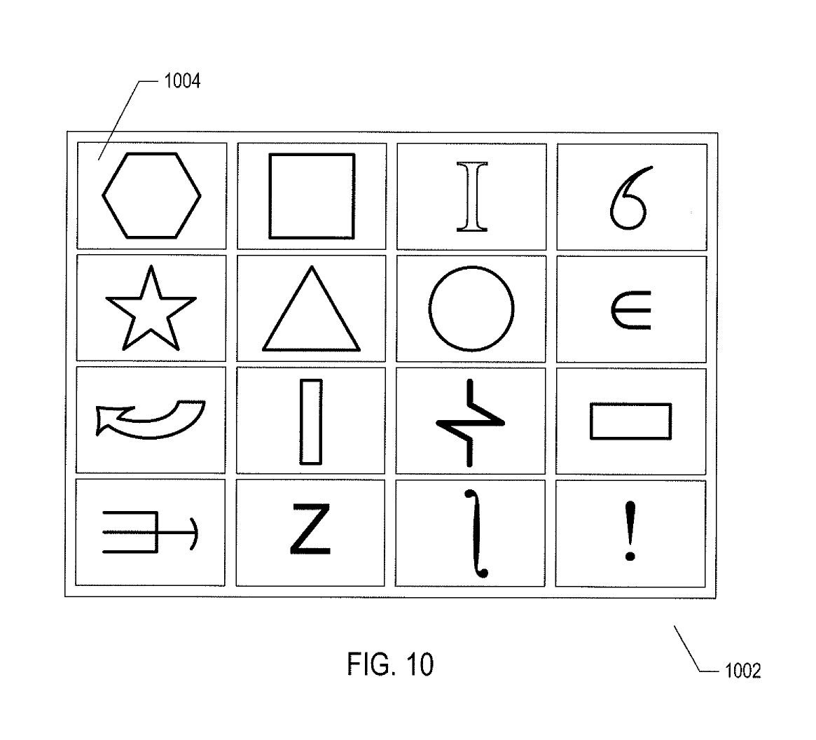

In this section, various types of hypothetical user inputs to a hypothetical soft-input panel are discussed. FIG. 10 illustrates a hypothetical, arbitrary soft-input panel. The soft-input panel (“SIP”) includes 16 different input features, or keys, arranged in four columns and four rows, and each associated with a symbol displayed within the surface area of the SIP corresponding to the key. For example, a first key, or display feature, 1004 may be touched by a user to input a hexagonal symbol to an electronic device, such as a mobile phone.

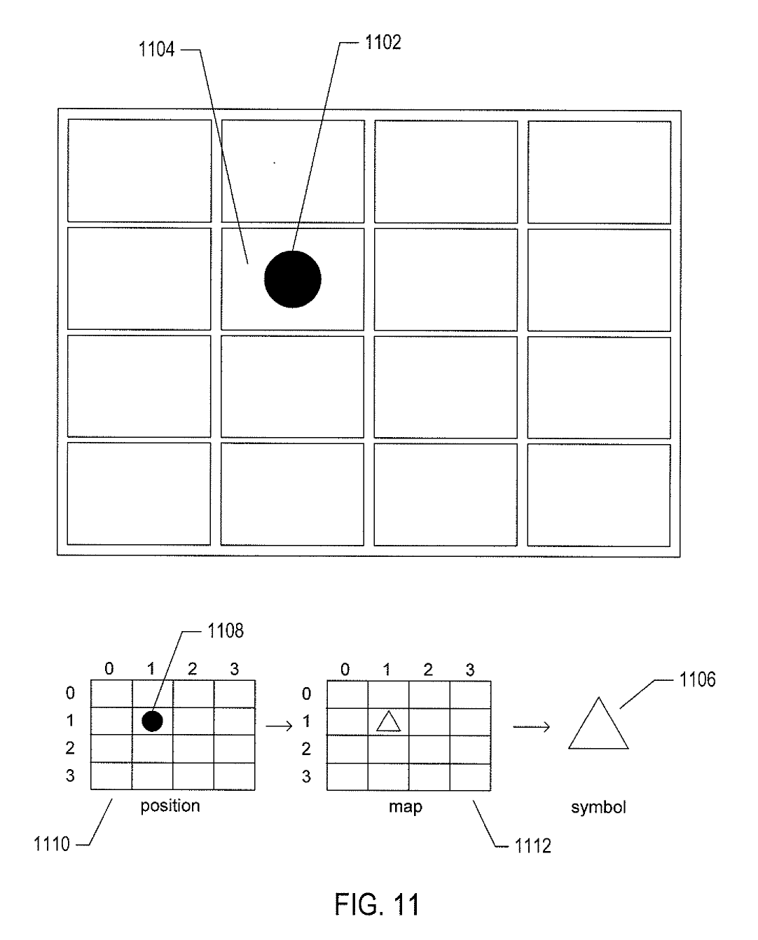

FIG. 11 illustrates a first type of user-input operation with respect to the hypothetical SIP shown in FIG. 10. In this operation, represented in FIG. 11 and in subsequent figures by a large shaded disk 1102 superimposed over an input key 1104, a user touches an input key in order to input a symbol associated with the input key. Processing of this type of user input is illustrated in the lower portion 1106 of FIG. 11. A control program senses the position of the user's touch 1108 with respect to a coordinate system 1110 logically superimposed over the SIP and maps that position to a symbol based on a map 1112 that associates symbols to regions of the SIP corresponding to keys.

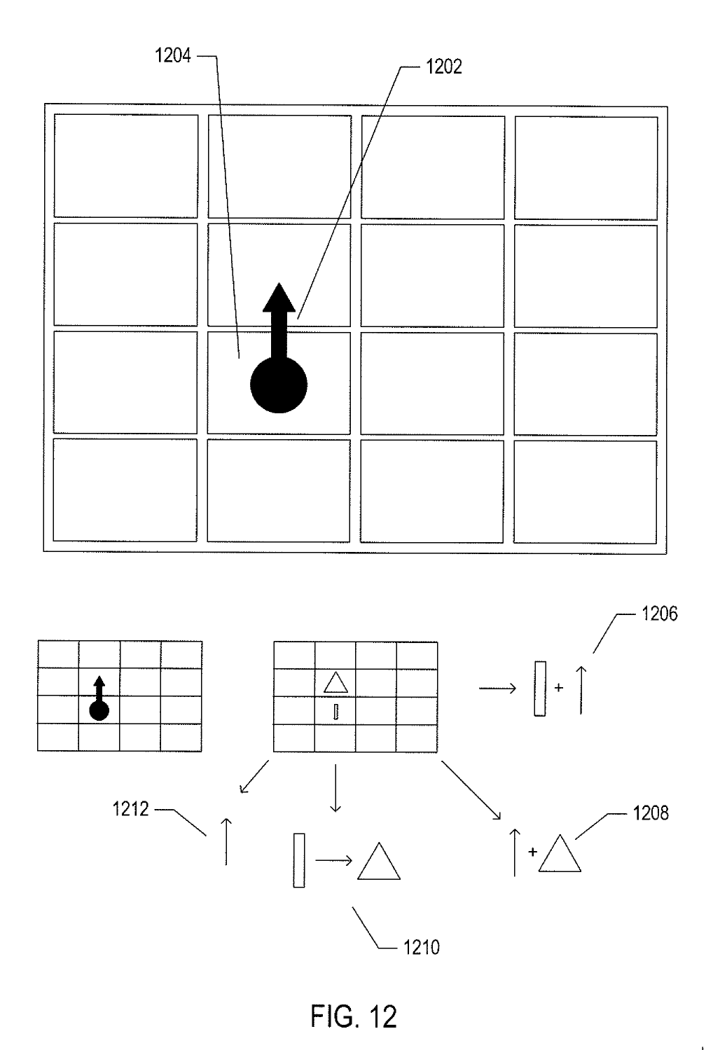

FIG. 12 illustrates a second type of user-input operation, using the illustration conventions of FIGS. 10-11. In the second type of user input, the user briefly touches a particular position of the SIP and then briefly moves the user's thumb or finger in a particular direction. This type of user input is generally referred to as a “flick,” “gesture” or, more particularly, as a “directional gesture.” The gesture is represented, in FIG. 12, by a shaded disk and associated directional arrow 1202, with the shaded disk superimposed over the input key 1204 initially touched by the user. A control program may interpret the gesture in different ways, depending on a particular context in which the gesture is input, arbitrary meanings given to gestures by the control program, and other considerations. For example, as shown in FIG. 12, gesture 1202 input to the hypothetical SIP shown in FIG. 10 may be alternatively interpreted, by various different SIP-control-program implementations, as: (1) a vertical-bar symbol associated with key 1204 and an upward-direction indication 1206; (2) an upward-direction indication and triangular symbol 1208, the triangular symbol associated with the input key where the gesture ended; (3) a sequence of a vertical bar symbol and triangular symbol 1210; or (4) an upward-direction indication 1212.

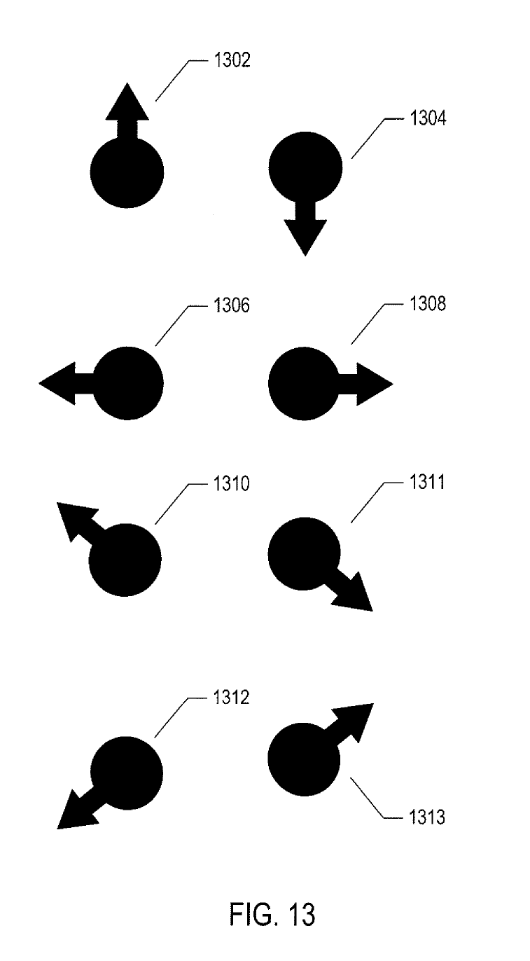

FIG. 13 illustrates various different directional-gesture symbols representing different input gestures. In certain cases, only four directions may be recognized by an input device and control program, such as upward 1302, downward 1304, leftward 1306, and rightward 1308 directions. Alternatively, four diagonal directions 1310-1313 may be alternatively recognized by an input device and control program. In yet additional cases, an input device and control program may recognize all eight of the gesture directions shown in FIG. 13. Although it would be possible to attempt to recognize many different radial directions emanating from an initial touch point, practically, in small mobile devices operated using a single digit or thumb, it is better to attempt to recognize only a few different directions associated with directional gestures, such as the four directions of directional gestures 1302, 1304, 1306, and 1308 shown in FIG. 13, since a user can indicate directions with only limited precision.

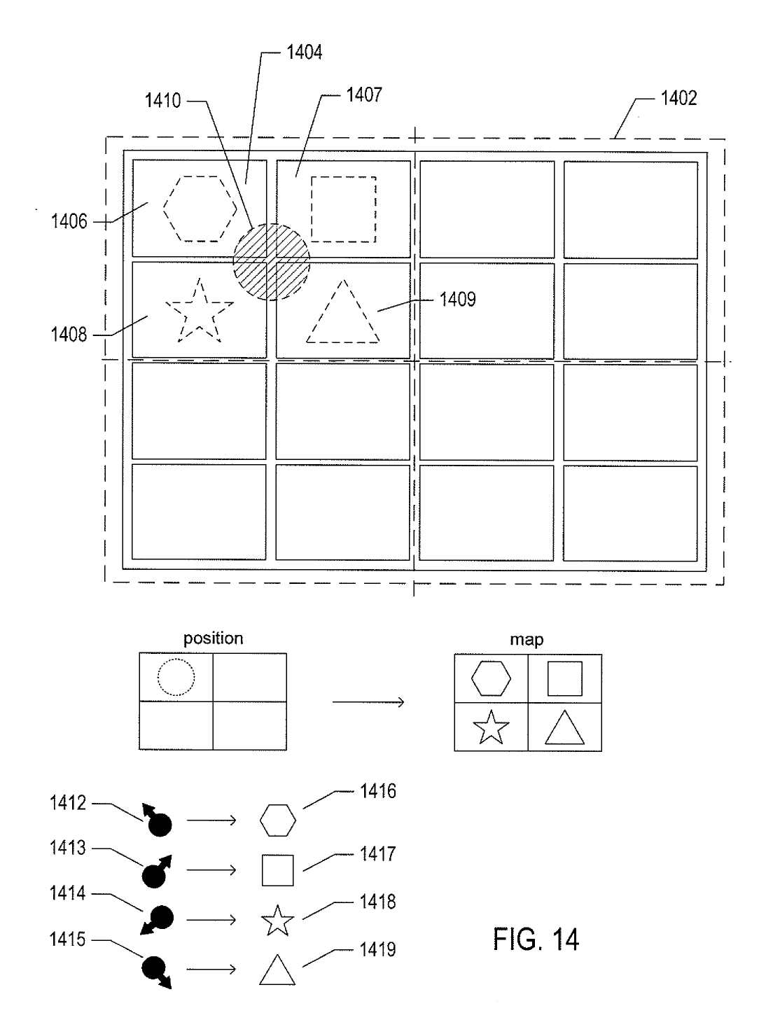

FIG. 14 illustrates a third type of user-input operation, using the illustration conventions of FIGS. 10-13. In the case shown in FIG. 14, the SIP is divided into four regions, as indicated by dashed lines, such as dashed line 1402, each region comprising four input features, or keys, arranged in two rows and columns. For example, a first region 1404 includes input keys 1406-1409. The initially touched location at the beginning of a directional gesture, for example the initial touch represented by crosshatched disk 1410 in FIG. 14, is associated with one of the four regions, rather than with a particular key. The direction of a directional gesture is then used, in combination with the region corresponding to the initial touch, to select a particular input key. For example, given the initial touch point 1410 shown in FIG. 14, each of four different possible directional gestures 1412-1415 selects symbols 1416-1419, respectively. This type of user input is referred to, below, as a “region-based gesture.” The region-based gesture can be contrasted to a key-based gesture, as described above with reference to FIG. 12, which generally refers to a particular key.

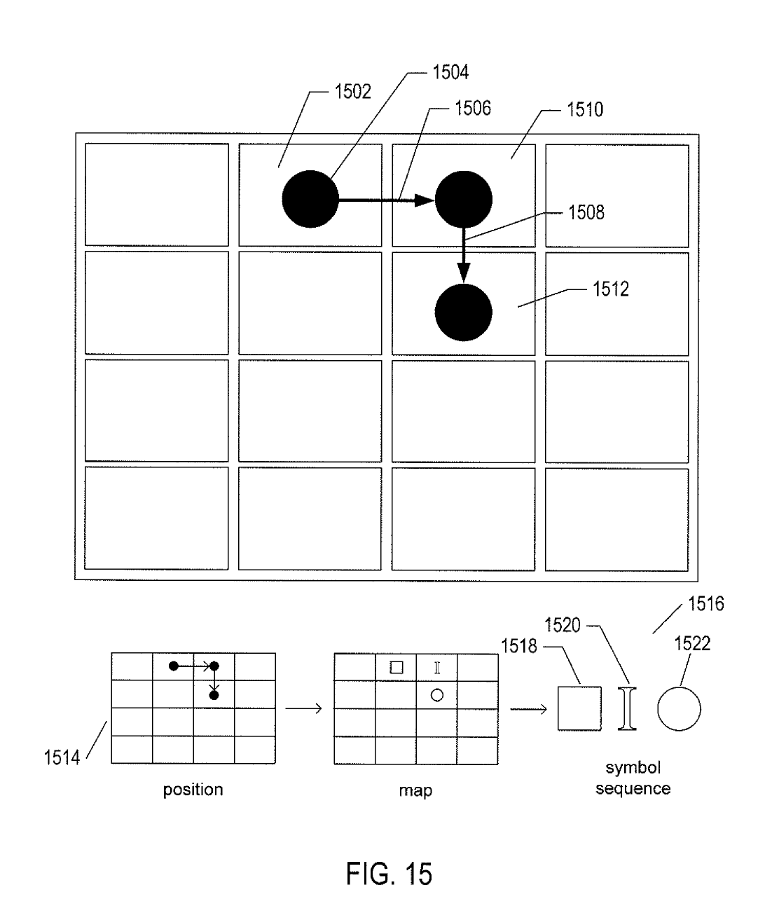

FIG. 15 illustrates a fourth type of user-input operation, using the illustration conventions of FIGS. 10-14. This type of user input is referred to as “continuous, sequential input.” In continuous, sequential input, a user initially touches a first key and then, in continuous fashion, moves the touching digit or thumb to one or more additional, adjacent keys in vertical and/or horizontal directions. For example, as shown in FIG. 15, a user initially touches input key 1502, as represented by shaded disk 1504, and then continuously moves the touching finger or thumb, as indicated by arrows 1506 and 1508, to input keys 1510 and 1512. This continuous, sequential input is interpreted by the input device and control program, as indicated in the lower portion of FIG. 15 1514, as the three-symbol sequence 1516 comprising a square symbol 1518, an “I”-like symbol 1520, and a circular symbol 1522 associated with keys 1502, 1510, and 1512.

### A 16-Key Korean-Language SIP Implementation that Represents an Example of the Korean-Language SIPs to which the Current Application is Directed

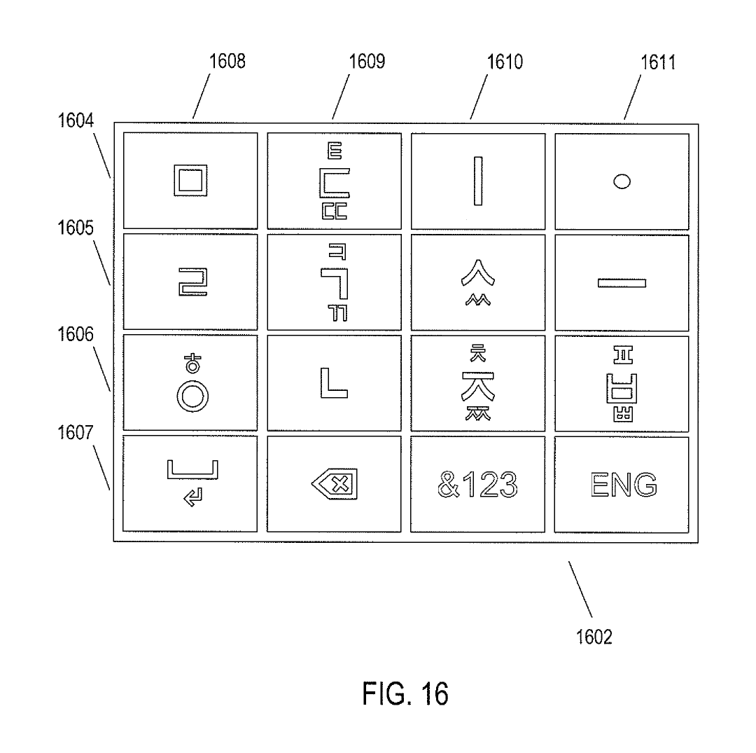

FIG. 16 shows one implementation of the 16-key Korean-language SIP to which the current application is directed. The 16-key Korean-language SIP 1602 includes 16 keys arranged in four rows 1604-1607 and four columns 1608-1611. The first three rows 1604-1606 include keys that each corresponds to one or more Hangul characters. The last row 1607 includes cursor-control and other control keys as well as toggles that involve alternative SIPs for input of punctuation and numeric symbols and English language characters.

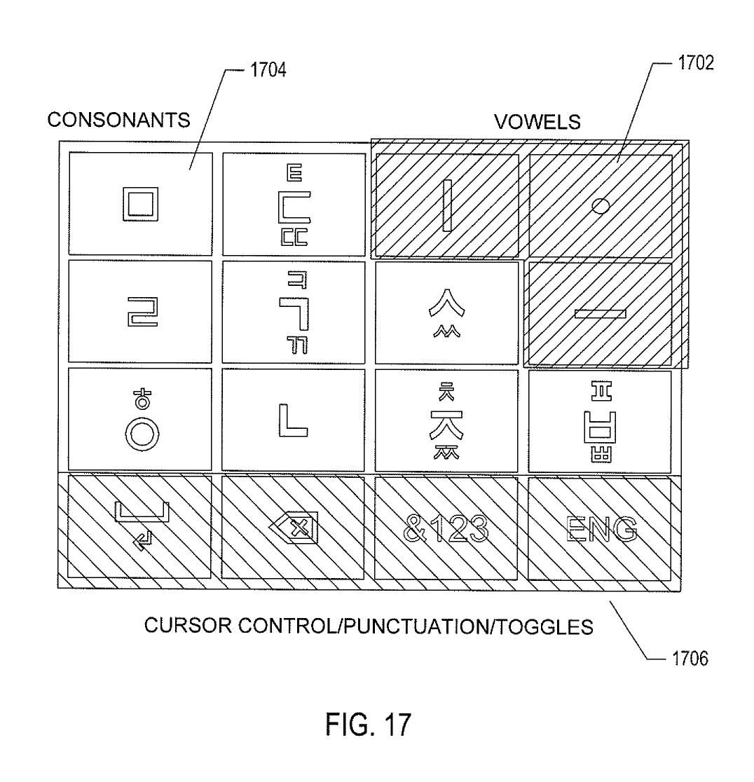

FIG. 17 shows the 16-key Korean-language SIP of FIG. 16 with superimposed crosshatching to indicate three functional regions of the 16-key Korean-language SIP. As shown in FIG. 17 with narrow crosshatching, a first, upper-right-hand functional region 1702 includes three keys used to compose Hangul vowels. A second, non-crosshatched region 1704 includes keys for entering Hangul consonants. The final, lower crosshatched region 1706, as discussed above, includes cursor-control and other control keys as well as a punctuation/numeric-symbol SIP toggle and an English-language-SIP toggle.

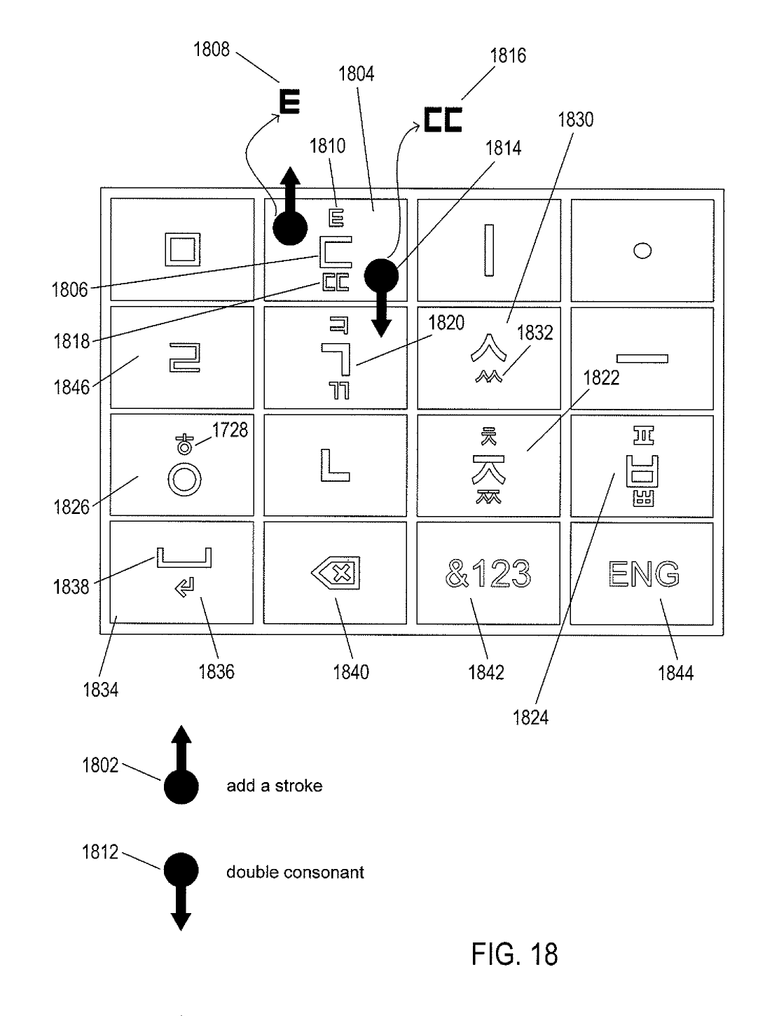

FIG. 18 illustrates two different types of gestures used with certain of the keys corresponding to consonants within the 16-key Korean-language SIP shown in FIG. 16. Each of the Hangul-character-associated keys in the first three rows corresponds to a primary Hangul character with a stroke that is centrally and most prominently displayed within the key. A single-key touch input, described above with reference to FIG. 11, is directed to a key of the first three rows in order to input a centrally and prominently displayed Hangul character associated with the key, with the exception of the short-stroke input key, discussed further below, used only for composing multi-stroke vowels. In certain cases, an upward-directed gesture 1802 directed to a key results in input of a character with an appearance similar to that of the centrally and prominently displayed character but which includes an additional stroke. For example, an upward-directed gesture directed to the key 1804 that centrally and prominently displays the consonant diegut 1806 adds a stroke to the consonant diegut to produce the consonant tieut 1808. This key displays, in smaller font, the consonant tieut 1810 above the centrally and prominently displayed consonant diegut 1806 to indicate to the user that an upward-directed gesture directed to key 1804 will input the consonant tieut 1810 rather than the consonant diegut 1806.

For certain keys of the 16-key Korean-language SIP, input of a downward-directed gesture 1812 to a key that centrally and prominently displays a consonant results in input of a double consonant in which the centrally and prominently displayed consonant is twice repeated. As an example, input of a downward-directed gesture 1814 to the key 1804 that centrally and prominently displays the consonant diegut 1806 results in input of the double consonant ssangdigeut 1816 rather than diegut 1806, as indicated by the ssangdigeut character 1818 displayed below the centrally and prominently displayed diegut character 1806 within key 1804. Similar directional-gesture inputs can be used for key 1820, which centrally and prominently displays the consonant giyeok, key 1822 which centrally and prominently displays the consonant jieut, and key 1824 which centrally and prominently displays the consonant bieup. An upward-directed gesture can be input to key 1826, which prominently displays the consonant ieung, to input the consonant hieut 1828 and a downward-directed gesture can be input to the key 1830, which centrally and prominently displays the consonant siot to input the consonant ssangsiot 1832. In similar fashion, key 1834, which centrally and prominently displays a space symbol, can, when a downward-directed gesture is input, result in an enter or return control function, shown by symbol 1836 below the space symbol 1838. The backspace key 1840, punctuation and numeric SIP toggle key 1842, and English-language SIP toggle key 1844 all receive only touch input as discussed above with reference to FIG. 11.

In certain implementations, continuous, sequential input beginning on a first key associated with a consonant and ending on a second key associated with a consonant can be used to input certain of the double consonants. For example, continuous, sequential input to keys 1846 and 1820 can be used to input the double consonant 812 shown in FIG. 8C.

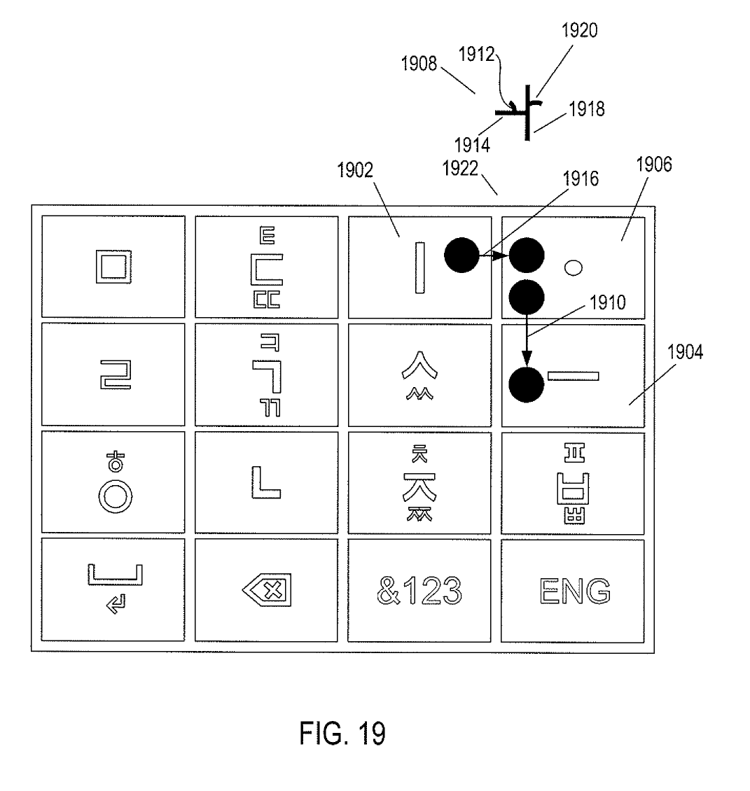

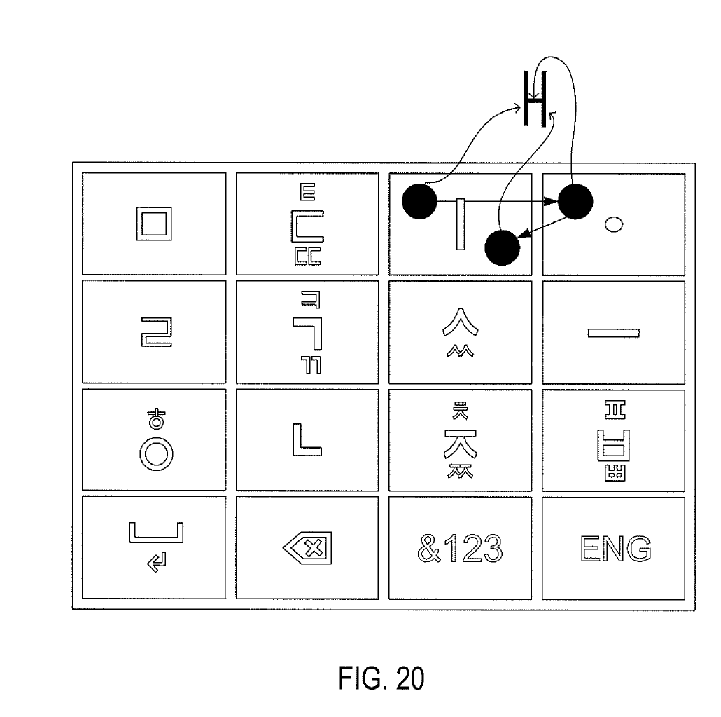

FIGS. 19 and 20 show input of Hangul vowel characters using the 16-key Korean-language SIP shown in FIG. 16. A single touch input, as discussed above with reference to FIG. 11, can be used with respect to key 1902 and key 1904 to input the single-stroke vowels i and eu, respectively. All other vowels are composed of two or more strokes, each stroke corresponding to one of the keys 1902, 1904, and 1906. FIG. 19 illustrates input of the vowel wa. A user uses two continuous, sequential inputs, as discussed above with reference to FIG. 15, to construct the vowel wa 1908. The user begins by directing a first continuous-sequential input, represented by arrow 1910, starting with key 1906, corresponding to the first short stroke 1912 of the vowel wa, and ending with key 1904, corresponding to the first horizontal stroke 1914 of the vowel wa. The user finishes composing the vowel wa by directing a second continuous-sequential input, represented by arrow 1916, starting with key 1902, corresponding to the first vertical stroke 1918 of the vowel wa, and ending with key 1906, corresponding to the second short stroke 1920 of the vowel wa. FIG. 20, using the same illustration conventions as used in FIG. 19, illustrates composition of the vowel ae using the Hangul vowel-stroke-associated keys 1902, 1904, and 1906 discussed with reference to FIG. 19.

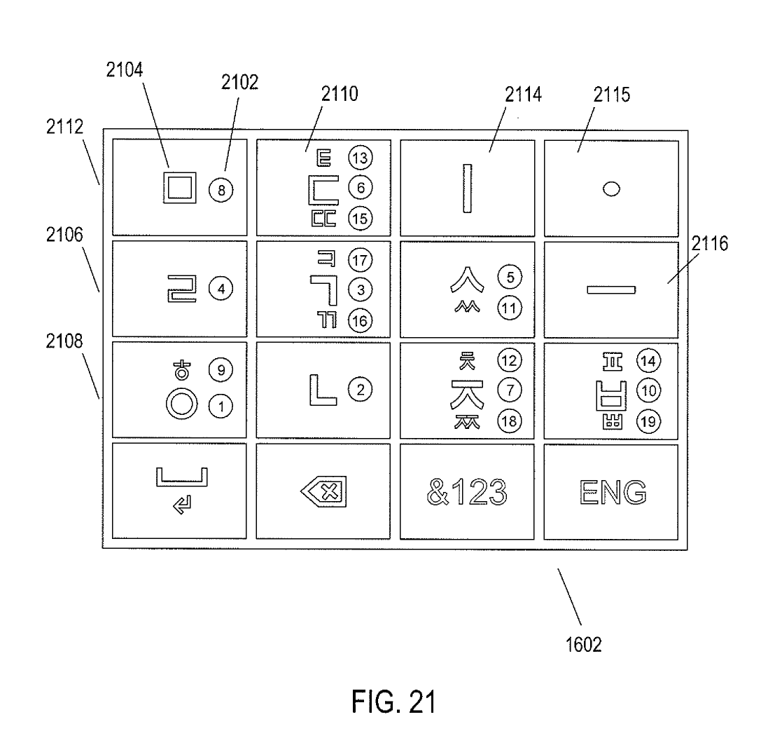

FIG. 21 shows the 16-key Korean-language SIP of FIG. 16 with circled frequency-of-occurrence ranks associated with each of the displayed consonant characters. For example, the circled number “8” 2102 next to the consonant mieum 2104 indicates that the consonant mieum is the eighth-most frequently occurring consonant. In examining FIG. 21, it is readily apparent that the most frequently used consonants are clustered within the right-hand three keys of the central rows 2106 and 2108 as well as in key 2110 in the first row 2112. These keys are most easily accessed by a right-handed user using a single hand to hold a mobile phone as well as input touches and gestures to an SIP displayed by the phone. Thus, the distribution of symbols over the keys of the 16-key Korean-language SIP is not arbitrary, but is designed to facilitate easy access and manipulation by users. The three keys 2114-2116 associated with Hangul vowel strokes are located together to facilitate continuous, sequential composition of Hangul vowels in a fashion similar to previous and currently available input devices and SIPs. By associating certain of the input keys with two or three consonants, rather than a single consonant, only 16 input keys are needed for fully functional Korean-language-character input, allowing the keys to have sufficient size to be easily accessed by users. The consonant-associated keys, the vowel-stroke-associated keys, and the control and toggle keys are grouped into distinct functional regions of the 16-key Korean-language SIP to provide simple and intuitive, function-based interaction to users.

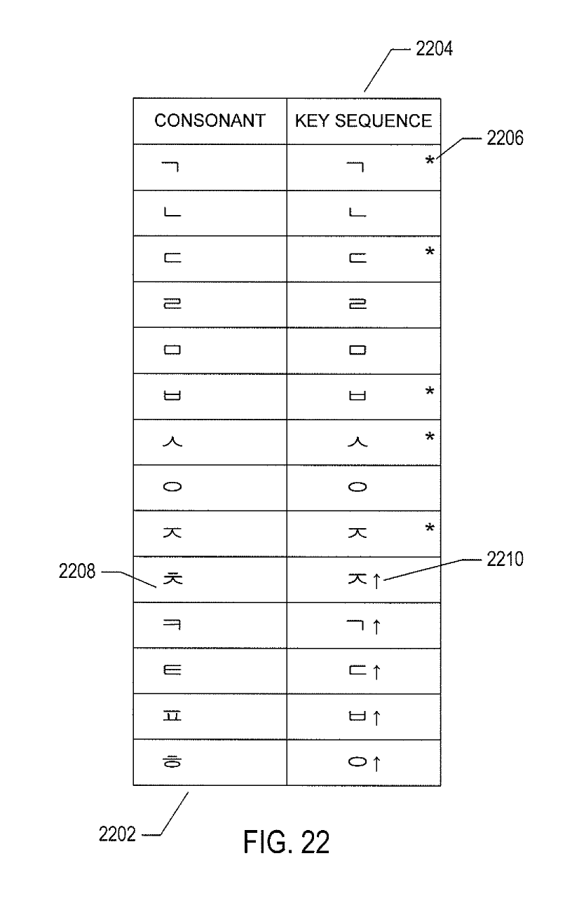

FIG. 22 shows the keys and key sequences used to input consonants via the 16-key Korean-language SIP shown in FIG. 16. The basic consonants of the Hangul alphabet are shown in the first column 2202. The key or key sequence used to input each consonant is shown in the second column 2204. Those consonants that can be doubled using a downward-directed gesture are indicated with asterisks, such as asterisk 2206. The first nine consonants are input by touching the key associated with a consonant, using the input type discussed above with reference to FIG. 11. The final five consonants are input using an upward-directed gesture directed to a key that centrally and prominently displays a similar but different consonant, as discussed above with reference to FIG. 18. For example, the consonant chieut 2208 is input by inputting an upward-directed gesture to the key associated with consonant jieut, as indicated by the symbol for the consonant jieut and upward-pointing arrow combination 2210.

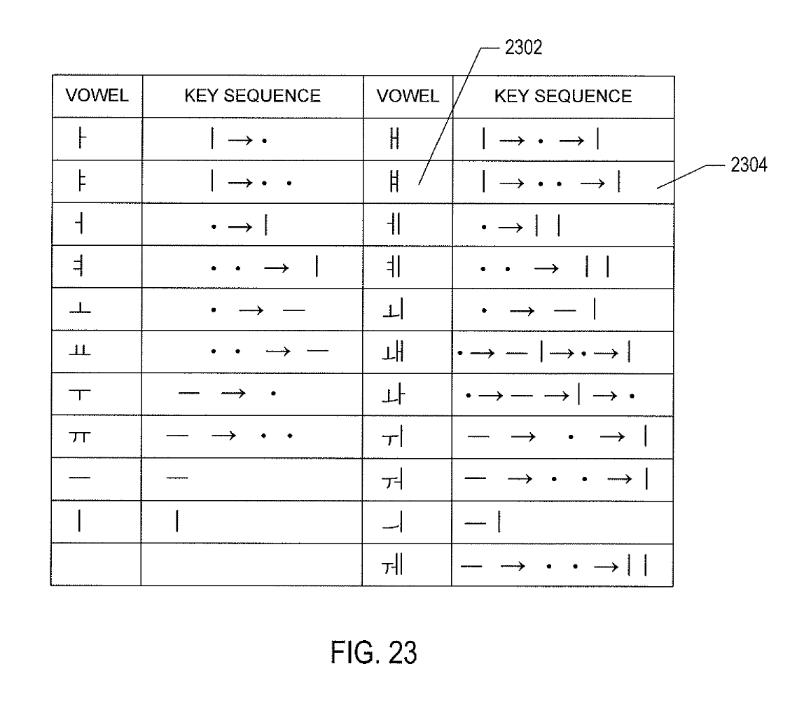

FIG. 23 shows the region-based gestures used to compose each of the Hangul vowels via the 16-key Korean-language SIP shown in FIG. 16. The key sequences are shown as strokes interconnected by arrows to indicate continuous movement of the digit or thumb. Strokes without interconnecting arrows are input by lifting the finger or thumb and again touching the key with the finger or thumb. For example, the vowel yae 2302 is input by touching the vertical stroke key, continuously moving the touching digit or thumb to the short-stroke key, retouching the short-stroke key and then moving the touching finger or thumb to the vertical-stroke key, as indicated by the sequence 2304 shown in FIG. 23.

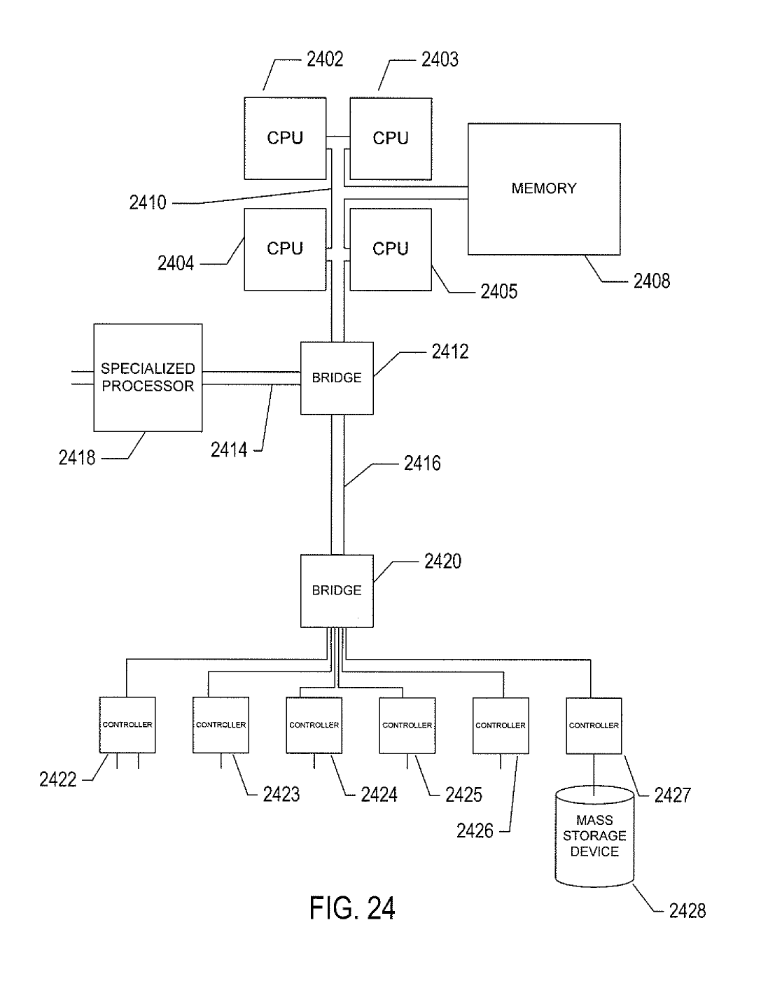

While mobile phones represent one type of electronic device within which Korean-language SIPs and HIPs can be deployed, the Korean-language SIPs and HIPs to which the current application is directed may also be incorporated within many other types of electronic devices, including tablet computers, laptop computers, personal computers, electronic kiosks, and other types of electronic devices that support user input through a SIP or HIP. FIG. 24 illustrates a general-purpose computer system. The computer system contains one or multiple central processing units (“CPUs”) 2402-2405, one or more electronic memories 2408 interconnected with the CPUs by a CPU/memory-subsystem bus 2410 or multiple busses, a first bridge 2412 that interconnects the CPU/memory-subsystem bus 2410 with additional busses 2414 and 2416, or other types of high-speed interconnection media, including multiple, high-speed serial interconnects. These busses or serial interconnections, in turn, connect the CPUs and memory with specialized processors, such as a graphics processor 2418, and with one or more additional bridges 2420, which are interconnected with high-speed serial links or with multiple controllers 2422-2427, such as controller 2427, that provide access to various different types of mass-storage devices 2428, electronic displays, input devices, and other such components, subcomponents, and computational resources. Tablet computers, personal computers, and many other computing devices in which Korean-language SIPs and HIPs are incorporated may be described by the general-purpose computer architecture shown in FIG. 24, or by related architectures.

Although the present invention has been described in terms of particular embodiments, it is not intended that the invention be limited to these embodiments. Modifications within the spirit of the invention will be apparent to those skilled in the art. For example, the positions of certain of the key-associated symbols and characters within the 16-key Korean-language SIP shown in FIG. 16 may be shifted or interchanged and the vowel-stroke, consonant, and control/toggle regions may be alternatively distributed across the SIP. As one example, the relative locations of the vowel-composition region, the consonant-composition region, and the control-and-toggle region may be changed to accommodate a left-hand user with respect to the relative locations of the vowel-composition region, the consonant-composition region, and the control-and-toggle region for a right-hand user. For a Korean-language SIP, the relative locations may be changed according input to the electronic device that includes the Korean-language SIP. For a Korean-language HIP with keys that electronically display symbols, the relative locations may be similarly changed. For a Korean-language HIP with keys imprinted or labelled with symbols, different versions of the electronic device may be manufactured for left-handed and right-handed users. Any number of different implementations may be obtained using different electronic display and input devices and by varying the implementation parameters of the underlying control program, including modular organization, programming language, operating system, control structures, data structures, and other such implementation parameters. In certain implementations, space-separated groups of input characters may be arranged to form morpho-syllabic blocks by the 16-key Korean-language SIP and control program for display in a text-entry window. In certain implementations, when a user input is directed to the Korean-language input panels may, the control program that controls the Korean-language input panels may generate audio tones or haptic feedback, such as vibrations, mechanical forces, and other tactile signals, to provide non-visual cues with regard to where, within the Korean-language input panels, the user input was directed. In certain implementations, user input directed to a particular location within a Korean-language soft-input panel may result in resizing of an input key or region at that location, or may result in generation of other visual cues in Korean-language SIPs and HIPs. Such visual cues may also be generated predicatively, by the control program, to facilitate accurate input by users. In certain implementations, the shapes, sizes, and appearance of the input features of the Korean-language SIPs and HIPs may differ from those shown in FIGS. 16-21, and may also be altered by user input or input-panel configuration operations.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A Korean-language input-panel component of an electronic device, the Korean-language input panel comprising:
a control program executed by a processor within the electronic device;
an electronic memory that stores character sequences input through the Korean-language input panel; and
input keys arranged into three different functional regions, each functional region containing related input keys that are adjacent to one another along one or two sides, the functional regions including a vowel-composition region, a consonant-composition region, and a control-and-toggle region, two or more of the input keys in the consonant-composition region implemented to recognize and differently respond to touch and key-based-gesture input operations.

2. The Korean-language input panel of claim 1 wherein the vowel-composition region includes three vowel-stroke input keys, including:
a vertical-stroke input key;
a short-stroke input key; and
a horizontal-stroke input key.

3. The Korean-language input panel of claim 2
wherein the vowel i is input by a touch input to the vertical-stroke input key;
wherein the vowel eu is input by a touch input to the horizontal-stroke input key; and
wherein all vowels other than i and eu are constructed by one or more inputs to two or more of the three vowel-stroke input keys, the one or more inputs selected from single-key touch inputs and continuous, sequential inputs.

4. The Korean-language input panel of claim 1 wherein the consonant-composition region includes 9 consonant-input keys, each of which prominently displays a different Hangul consonant that is input when a touch input is directed to the consonant-input key.

5. The Korean-language input panel of claim 4 wherein the 9 consonant-input keys include consonant-input keys that prominently display:
the consonant mieum;
the consonant digeut;
the consonant rieul;
the consonant giyeok;
the consonant siot;
the consonant ieung;
the consonant nieun;
the consonant jieut; and
the consonant bieup.

6. The Korean-language input panel of claim 4 wherein two or more of the consonant-input keys each less prominently displays a second consonant formed by adding a stroke to the consonant prominently displayed by the consonant-input key, the second consonant input by inputting a first type of key-based gesture to the consonant-input key.

7. The Korean-language input panel of claim 6
wherein the consonant-input key that prominently displays the consonant digeut additionally less prominently displays the consonant tieut that includes an additional stroke with respect to the consonant digeut;
wherein the consonant-input key that prominently displays the consonant giyeok additionally less prominently displays the consonant kieuk that includes an additional stroke with respect to the consonant giyeok;
wherein the consonant-input key that prominently displays the consonant ieung additionally less prominently displays the consonant hieut that includes an additional stroke with respect to the consonant ieung;
wherein the consonant-input key that prominently displays the consonant jieut additionally less prominently displays the consonant chieut that includes an additional stroke with respect to the consonant jieut; and
wherein the consonant-input key that prominently displays the consonant bieup additionally less prominently displays the consonant pieup that includes an additional stroke with respect to the consonant bieup.

8. The Korean-language input panel of claim 4 wherein two or more of the consonant-input keys each less prominently displays a second consonant formed by doubling the consonant prominently displayed by the consonant-input key, the second consonant input by inputting a second type of key-based gesture to the consonant-input key.

9. The Korean-language input panel of claim 6
wherein the consonant-input key that prominently displays the consonant digeut additionally less prominently displays the consonant ssangdigeut comprising a sequence of two consonants digeut;
wherein the consonant-input key that prominently displays the consonant giyeok additionally less prominently displays the consonant ssanggiyeok comprising a sequence of two consonants giyeok;
wherein the consonant-input key that prominently displays the consonant bieup additionally less prominently displays the consonant ssangbieup comprising a sequence of two consonants bieup;
wherein the consonant-input key that prominently displays the consonant siot additionally less prominently displays the consonant ssangsiot comprising a sequence of two consonants siot; and
wherein the consonant-input key that prominently displays the consonant jieut additionally less prominently displays the consonant ssangjieut comprising a sequence of two consonants jieut.

10. The Korean-language input panel of claim 1
wherein the Korean-language input panel comprises 16 input keys arranged in four rows each containing four input keys;
wherein the vowel-composition region includes the last two input keys of the first row and last input key of the second row;
wherein the consonant-composition region includes the first two input keys of the first row and all four input keys of the second and third rows; and
wherein the control-and-toggle region includes all four input keys of the fourth row.

11. Korean-language input panel of claim 10 wherein the relative locations of the vowel-composition region, the consonant-composition region, and the control-and-toggle region may be changed to accommodate a left-hand user with respect to the relative locations of the vowel-composition region, the consonant-composition region, and the control-and-toggle region for a right-hand user.

12. A Korean-language input-panel component of an electronic device, the Korean-language input panel comprising:
a control program executed by a processor within the electronic device;
an electronic memory that stores character sequences input through the Korean-language input panel; and
16 input keys arranged into three different functional regions, each functional region containing related input keys that are adjacent to one another along one or two sides, the functional regions including a vowel-composition region that includes three vowel-stroke keys, a consonant-composition region that includes 9 consonant-input keys, and a control-and-toggle region that includes four input keys.

13. The Korean-language input panel of claim 12 wherein the vowel-composition region includes:
a vertical-stroke input key;
a short-stroke input key; and
a horizontal-stroke input key.

14. The Korean-language input panel of claim 13
wherein the vowel i is input by a touch input to the vertical-stroke input key;
wherein the vowel eu is input by a touch input to the horizontal-stroke input key; and
wherein all vowels other than i and eu are constructed by continuous sequential input to two or more of the three vowel-stroke input keys, the one or more inputs selected from single-key touch inputs and continuous, sequential inputs.

15. The Korean-language input panel of claim 12 wherein the consonant-composition region includes 9 consonant-input keys, each of which prominently displays a different Hangul consonant that is input when a touch input is directed to the consonant-input key, two or more of the consonant-input keys implemented to recognize and differently respond to touch and key-based gesture input operations.

16. The Korean-language input panel of claim 15 wherein two or more of the consonant-input keys each less prominently displays a second consonant formed by adding a stroke to the consonant prominently displayed by the consonant-input key, the second consonant input by inputting a first type of key-based gesture to the consonant-input key.

17. The Korean-language input panel of claim 4 wherein two or more of the consonant-input keys each less prominently displays a second consonant formed by doubling the consonant prominently displayed by the consonant-input key, the second consonant input by inputting a second type of key-based gesture to the consonant-input key.

18. A Korean-language input-panel component of an electronic device, the Korean-language input panel comprising:
a vowel-composition region containing vowel-stroke keys that are adjacent to one another along one or two sides;
a consonant-composition region containing constant-input keys that are adjacent to one another along one or two sides; and
a control-and-toggle region containing control and toggle keys that are adjacent to one another along one or two sides.

19. The Korean-language input panel of claim 18 wherein the vowel-composition region includes three vowel-stroke input keys, including:
a vertical-stroke input key;
a short-stroke input key; and
a horizontal-stroke input key.

20. The Korean-language input panel of claim 18 wherein the consonant-composition region includes 9 consonant-input keys, each of which prominently displays a different Hangul consonant that is input when a touch input is directed to the consonant-input key, two or more of which each less prominently displays a second consonant formed by adding a stroke to the consonant prominently displayed by the consonant-input key, and two or more of which each less prominently displays a second consonant formed by doubling the consonant prominently displayed by the consonant-input key.
